(19) United States
(12) Patent Application Publication
(10) Pub. No.: US 2023/0124089 A1
(43) Pub. Date: Apr. 20, 2023

(54) IMMERSIVE DISPLAY DEVICE WITH FREE-FORM REFLECTOR

(71) Applicant: KOREA PHOTONICS TECHNOLOGY INSTITUTE, Gwangju (KR)

(72) Inventors: Seon Kyu YOON, Gwangju (KR); Ha Mong SHIM, Gwangju (KR); Jin Su LEE, Gwangju (KR); Sung Kuk CHUN, Gwangju (KR)

(21) Appl. No.: 17/509,305

(22) Filed: Oct. 25, 2021

(30) Foreign Application Priority Data
Oct. 14, 2021 (KR) 10-2021-0136366

(51) Int. Cl. G02B 5/10; G03B 21/28

(52) U.S. Cl. CPC G02B 5/10; G03B 21/28

(57) ABSTRACT

According to an embodiment, there is provided a reflector reflecting an immersive image output from a projector to a screen to allow a viewer to recognize the immersive image. The reflector comprises a central portion that is flat within a predetermined range with respect to a center of the reflector and a curved portion having a curvature out of the predetermined range.

### STATEMENT REGARDING GOVERNMENT SPONSORED RESEARCH OR DEVELOPMENT

This disclosure was made with the support of the Agency for Defense Development under Project No. 1415165916 (Detailed Project Number: 18-CM-DP-24-MKE, Project Title: Development of Digital Holographic Optical Device for Immersive Display Applications, Year; 2019) sponsored by the Korean government (Ministry of Trade, Industry and Energy).

### CROSS-REFERENCE TO RELATED APPLICATION(S)

This application is based on and claims priority under 35 U.S.C. 119 to Korean Patent Application No. 10-2021-0136366, filed on Oct. 14, 2021, in the Korean Intellectual Property Office, the disclosure of which is herein incorporated by reference in its entirety.

### TECHNICAL FIELD

Embodiments of the disclosure relate to an immersive display device with a free-form reflector.

### DESCRIPTION OF RELATED ART

The description of the Discussion of Related Art section merely provides information that may be relevant to embodiments of the disclosure but should not be appreciated as necessarily constituting the prior art.

The immersive display technology provides immersion that allows an observer to observe only image information by means of a large-screen display. In this case, the angle of view (or field of view) of the large screen is 40 degrees or more. Accordingly, to increase immersion, the immersive display technology provides an optimal image observation environment by arranging images on a flat screen in the form of a cave, a hemisphere, a cylinder, and a horopter.

Conventional immersive display devices are implemented with an output device for outputting immersive images and a screen for viewing the immersive images. The conventional immersive display device, rather than directly outputting the image to the display surface, reflects the output image by a reflector and then outputs it to the display surface.

The human degree of perception varies depending on the angle of view. Although humans may recognize all content within a certain angular range, the quantity or quality of perceived content is significantly reduced as going out of the angular range.

In this case, the conventional immersive display device processes the image output on the display surface to have a uniform resolution. Accordingly, the conventional immersive display device needs to provide images having a high resolution so that the viewer may recognize high-resolution images. The conventional immersive display device suffers from considerable computation loads in image processing.

### SUMMARY

According to an embodiment of the disclosure, there is provided an immersive display device that provides optimized immersive images to the viewer using a free-form reflector.

According to an embodiment, there is provided a reflector reflecting an immersive image output from a projector to a screen to allow a viewer to recognize the immersive image. The reflector comprises a central portion that is flat within a predetermined range with respect to a center of the reflector and a curved portion having a curvature out of the predetermined range.

According to an embodiment, the curved portion may have an end curved away from the projector.

According to an embodiment, the central portion may reflect incident light to a predetermined first portion of the screen, and the curved portion may reflect the incident light to a second portion of the screen other than the first portion.

According to an embodiment, an amount of optical information reflected to the first portion of the screen may be relatively larger than an amount of optical information reflected to the second portion of the screen.

According to an embodiment, the first portion of the screen may be within a predetermined angular range with respect to a center of a viewer's angle of view.

According to an embodiment, the predetermined angular range may be 60°.

According to an embodiment, there is provided a reflector reflecting an immersive image output from a projector to a screen to allow a viewer to recognize the immersive image. The reflector comprises a central portion that is curved in a predetermined first direction within a predetermined range with respect to a center of the reflector and a curved portion that is curved in a second direction opposite to the first direction, out of the predetermined range.

According to an embodiment, the central portion may have an end curved towards the projector.

According to an embodiment, the central portion may reflect incident light to a predetermined first portion of the screen, and the curved portion may reflect the incident light to a second portion of the screen other than the first portion.

According to an embodiment, an amount of optical information reflected to the first portion of the screen may be relatively larger than an amount of optical information reflected to the second portion of the screen.

According to an embodiment, the first portion of the screen may be within a predetermined angular range with respect to a center of a viewer's angle of view.

According to an embodiment, the predetermined angular range may be 60°.

As described above, according to the embodiments of the disclosure, it is possible to provide the viewer with optimized images considering the human physiological viewing elements using the free-form reflector.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 is a view illustrating a configuration of an immersive display device according to an embodiment of the disclosure;

FIG. 2 is a view illustrating an implementation example of an immersive display device according to an embodiment of the disclosure;

FIGS. 3A and 3B are views illustrating reflectors according to an embodiment of the disclosure;

FIGS. 4A and 4B are views illustrating examples in which an image output from an immersive display device is output to a screen according to an embodiment of the disclosure; and

FIG. 5 is a view illustrating information recognized by a human according to the human angle of view.

### DETAILED DESCRIPTION

Various changes may be made to the disclosure, and the disclosure may come with a diversity of embodiments. Some embodiments of the disclosure are shown and described in connection with the drawings. However, it should be appreciated that the disclosure is not limited to the embodiments, and all changes and/or equivalents or replacements thereto also belong to the scope of the disclosure. Similar reference denotations are used to refer to similar elements throughout the drawings.

The terms “first” and “second” may be used to describe various components, but the components should not be limited by the terms. The terms are used to distinguish one component from another. For example, a first component may be denoted a second component, and vice versa without departing from the scope of the disclosure. The term “and/or” may denote a combination(s) of a plurality of related items as listed or any of the items.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when a component is “directly connected to” or “directly coupled to” another component, no other intervening components may intervene therebetween.

The terms as used herein are provided merely to describe some embodiments thereof, but not to limit the disclosure. As used herein, the singular forms “a,” “an,” and “the” are intended to include the plural forms as well, unless the context clearly indicates otherwise. As used herein, the term “comprise,” “include,” or “have” should be appreciated not to preclude the presence or addability of features, numbers, steps, operations, components, parts, or combinations thereof as set forth herein.

Unless otherwise defined, all terms including technical and scientific terms used herein have the same meaning as commonly understood by one of ordinary skill in the art to which the embodiments of the disclosure belong.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the” are intended to include the plural forms as well, unless the context clearly indicates otherwise.

The components, processes, steps, or methods according to embodiments of the disclosure may be shared as long as they do not technically conflict with each other.

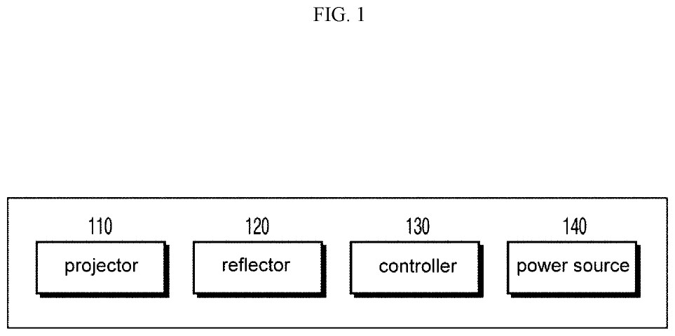

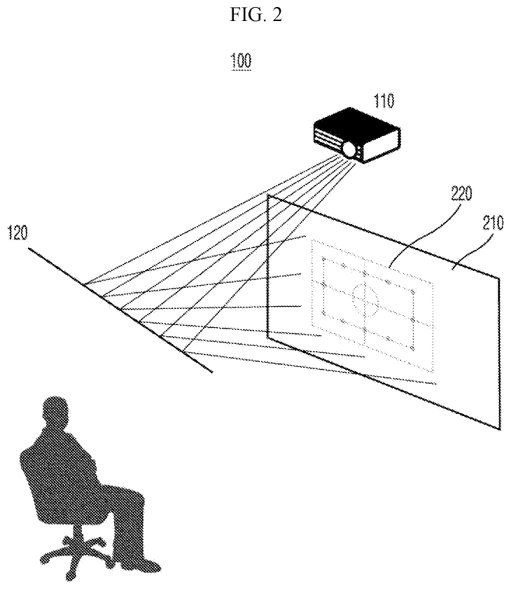

FIG. 1 is a view illustrating a configuration of an immersive display device according to an embodiment of the disclosure. FIG. 2 is a view illustrating an implementation example of an immersive display device according to an embodiment of the disclosure.

Referring to FIGS. 1 and 2, according to an embodiment, an immersive display device 100 includes a projector 110, a reflector 120, a controller 130, and a power source 140.

The projector 110 outputs an immersive image 220. The projector 110 outputs the immersive image 220 toward the reflector 120, and the immersive image 220 is reflected by the reflector 120 to a screen 210. The projector 110 is disposed in a position relatively higher than the uppermost end of the screen 210 so that the image output to the screen 210 is not blocked by the projector 110.

The reflector 120 receives the immersive image 220 output from the projector 110 and reflects it to the screen 210. The reflector 120 may be disposed in a position where the immersive image 220 output from the projector 110 may be fully received and is disposed at an angle at which the received immersive image 220 may be projected onto the screen 210. As the immersive image 220 is projected onto the screen 210 by the reflector 120, the viewer may recognize the immersive image 220.

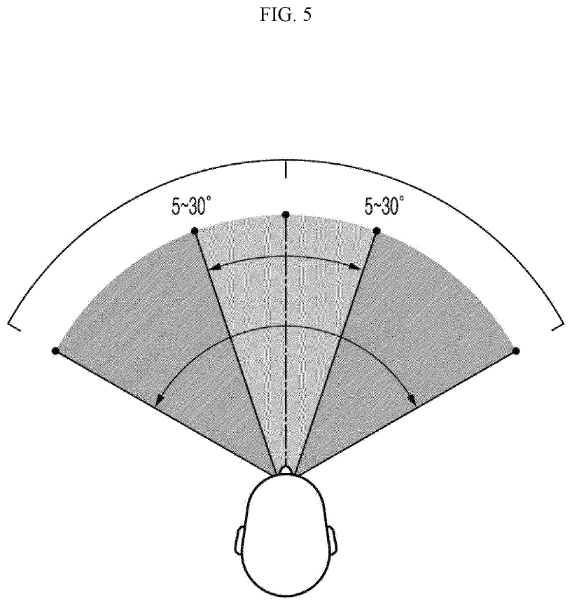

In this case, in recognizing the image output to a human, the human recognizes the image as illustrated in FIG. 5.

FIG. 5 is a view illustrating information recognized by a human according to the human angle of view.

Referring to FIG. 5, physiologically, a human may deeply recognize the content in the image output from an angular range of 10° (5° for the left eye or right eye) to an angular range of 60° (30° for the left or right eye) with respect to the center of their angle of view. However, out of the angular range, the human may simply recognize the shape or color but not the output content.

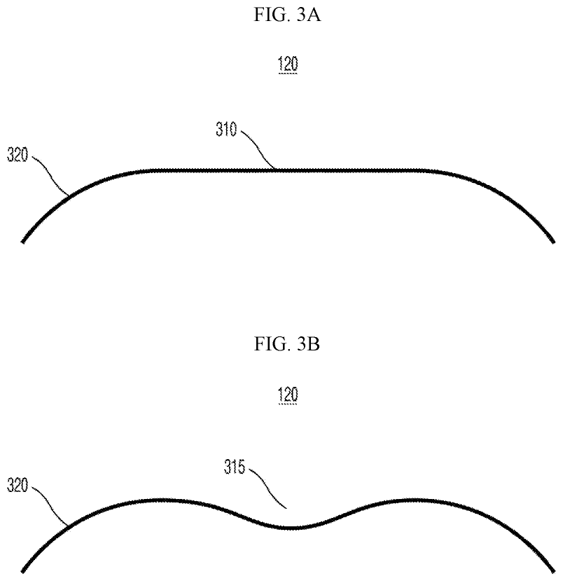

Referring back to FIGS. 1 and 2, considering such human physiological characteristics, the reflector 120 reflects the optical information corresponding to a preset level of resolution (e.g., more than half or more) of the output image to fall within the angle of view in which the human may recognize the content. The reflector 120 may be implemented in a free form and may be implemented to have the shape illustrated in FIG. 3A or 3B. As the reflector 120 is implemented in the shape illustrated in FIG. 3A or 3B, the above-described effect may be obtained.

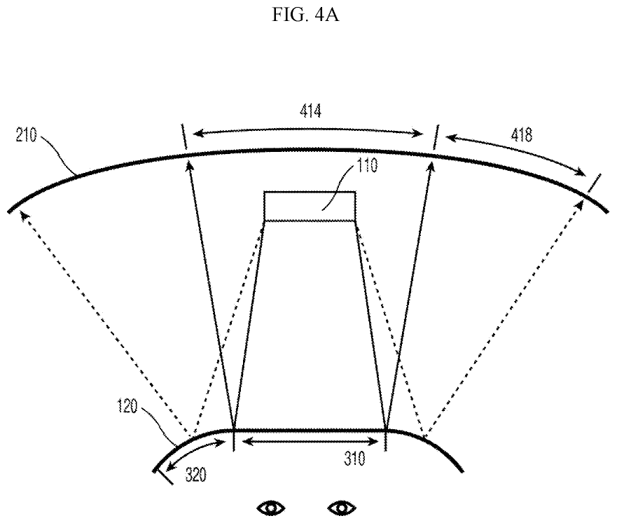

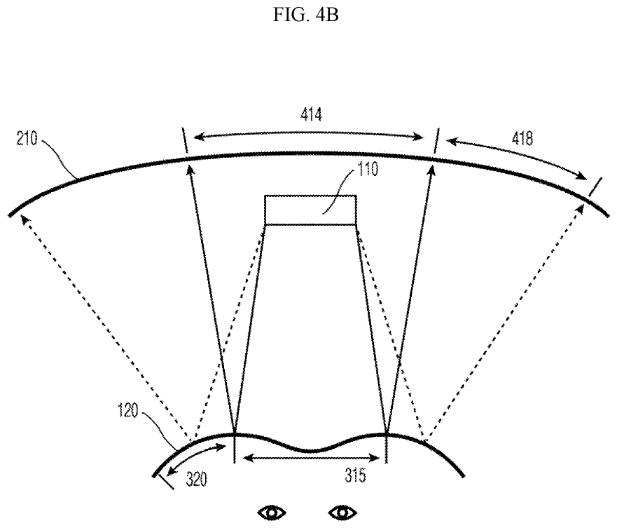

FIGS. 3A and 3B are views illustrating reflectors according to an embodiment of the disclosure. FIGS. 4A and 4B are views illustrating examples in which an image output from an immersive display device is output to a screen according to an embodiment of the disclosure.

As illustrated in FIG. 3A, the reflector 120 has a flat central portion 310 (within a preset range from the center) and two opposite ends 320 (curved portions) which have curvature away from the projector 110.

By such shape, the reflector 120 may present the effects illustrated in FIG. 4A. As the reflector 120 has the flat central portion 310 and the curved portions 320 having curvature, the reflector 120 reflects the light, output from the projector 110 and incident on the flat central portion 310, to a central portion 414 (within a range of 60° with respect to the center of the human angle of view) of the screen 210. Further, the reflector 120 reflects the light output, from the projector and incident on the curved portions 320, to outer portions 418 of the screen 210. In this case, by the structure of the curved portions 320 having curvature, even when light is incident in a relatively small range (quantity), the light may be dispersed by the curved portions 320 and reflected to the entire outer portions 418. Accordingly, even when the area of the central portion 414 and the area of the outer portion 418 are the same, a relatively larger amount of optical information may be incident on the central portion 310, and a relatively smaller amount of optical information may be incident on the curved portion 320. Accordingly, assuming that an image having a specific resolution is output, the viewer does not recognize that the image is output in the same resolution on the entire screen 210 as in the prior art but recognizes that a relatively high-resolution image is displayed on the central portion 414 and a relatively low-resolution image is displayed on the outer portion 418. As described with reference to FIG. 5, the viewer may clearly recognize the content only up to the image output to the central portion 414. Thus, the reflector 120 adjusts the path of the light output from the projector 110 to intentionally reflect a relatively large amount of optical information to the central portion 414. The optical information is a light factor that affects the resolution of the image perceived by the viewer and may include light quantity or light density. Accordingly, the viewer may perceive as if pixels are arranged at a relatively high density in the central portion 414. The degree of reflection of the central portion of the reflector 120 may exceed half (preferably, 2/3) of the total amount of light of the image output from the projector 110.

Meanwhile, as illustrated in FIG. 3B, the central portion 315 of the reflector 120 has a curvature in a direction opposite to the curved portion 320 (i.e., the ends of the central portion are closer to the projector). Since the central portion 315 has such a curvature, a greater amount of optical information may be easily reflected to the central portion 414 of the screen 210.

Referring back to FIGS. 1 and 2, according to the above-described characteristics of the reflector 120, the viewer may perceive as if an image having a higher resolution is output in a range that the viewer may perceive (the central portion of the screen).

The controller 130 controls the operation of the projector 110 and processes the image to be output.

The controller 130 controls the projector 110 to output an immersive image.

The controller 130 corrects the immersive image to be output by the projector 110. As described above, optical information of a preset level is reflected to the central portion 414 of the screen. Accordingly, if the projector 110 outputs the immersive image in the same way that an image with the same resolution is output on the entire screen 210, distortion may occur in the image perceived by the viewer. In particular, depending on the reflection angle, distortion may occur in the image. The controller 130 corrects the image to be output by the projector 110 considering the shape of the reflector 120 and the resultant reflection form. By the correction, the viewer may view a relatively high-resolution image on the central portion 414 of the screen without distortion.

The power source 140 supplies power to operate the projector 110 and the controller 130.

The above-described embodiments are merely examples, and it will be appreciated by one of ordinary skill in the art various changes may be made thereto without departing from the scope of the disclosure. Accordingly, the embodiments set forth herein are provided for illustrative purposes, but not to limit the scope of the disclosure, and should be appreciated that the scope of the disclosure is not limited by the embodiments. The scope of the disclosure should be construed by the following claims, and all technical spirits within equivalents thereof should be interpreted to belong to the scope of the disclosure.

1. A reflector reflecting an immersive image output from a projector to a screen to allow a viewer to recognize the immersive image, the reflector comprising:
a central portion that is flat within a predetermined range with respect to a center of the reflector; and
a curved portion having a curvature out of the predetermined range,
wherein the curved portion has an end curved away from the projector,
wherein the central portion reflects incident light to a predetermined first portion of the screen so that an amount of optical information reflected to the first portion of the screen is relatively larger than an amount of optical information reflected to a second portion of the screen other than the first portion,
wherein the curved portion disperses and reflects the incident light to the second portion of the screen and
wherein the first portion of the screen is within a predetermined angular range with respect to a center of a viewer's angle of view.

2-5. (canceled)

6. The reflector of claim 51, wherein the predetermined angular range is 60°.

7. A reflector reflecting an immersive image output from a projector to a screen to allow a viewer to recognize the immersive image, the reflector comprising:
a central portion that is curved in a predetermined first direction within a predetermined range with respect to a center of the reflector; and
a curved portion that is curved in a second direction opposite to the first direction, out of the predetermined range,
wherein the curved portion has an end curved away from the projector,
wherein the central portion reflects incident light to a predetermined first portion of the screen so that an amount of optical information reflected to the first portion of the screen is relatively larger than an amount of optical information reflected to a second portion of the screen other than the first portion,
wherein the curved portion disperses and reflects the incident light to the second portion of the screen and
wherein the first portion of the screen is within a predetermined angular range with respect to a center of a viewer's angle of view.

8-11. (canceled)

12. The reflector of claim 447, wherein the predetermined angular range is 60°.
